(19) United States
(12) Patent Application Publication
(10) Pub. No.: US 2009/0158954 A1
(43) Pub. Date: Jun. 25, 2009

(54) Self-Protection System for Combat Vehicles or Other Objects To Be Protected

(76) Inventors: Norbert Wardecki, Heuweiler (DE); Steffen Speer, Appenweiler (DE)

Correspondence Address: WOLFF & SAMSON, P.C., ONE BOLAND DRIVE, WEST ORANGE, NJ, 07052, US

(21) Appl. No.: 12/084,872

(22) PCT Filed: Nov. 8, 2006
(86) PCT No.: PCT/EP2006/010692

§ 371 Date: Jun. 5, 2008

(30) Foreign Application Priority Data
Nov. 11, 2005 (DE) 10 2005 054 275.1

(51) Int. Cl. F42B 4/00; G01S 13/00; F41G 3/00; G08B 21/00; G06K 9/00; G01J 5/00

(52) U.S. Cl. 102/335; 342/67; 89/41.01; 340/540; 382/103; 374/121

(57) ABSTRACT

The invention relates to a self-protection system (1) comprising at least one launching device (4) for initiating appropriate countermeasures against the threat, which comprises a sensor system (3) in the form of at least one sniper location detector or the like for detecting as well as locating a tank cover or rear cover position (6). A detection as well as a locating of the threat posed by the presence of a tank cover or rear cover position (6) ensues even before a shot is fired or before the threat. To this end, the launching device (4) is armed with pyrotechnic munitions (7), as a priority, irritation bodies or munition being integrated that, when fired, immediately produce an intense flash and/or smoke/fog (8).

The invention relates to a self-protection system in accordance with the preamble to patent claim 1.

The use of fog and decoys for protecting vehicles on water, land, and in the air, in addition to other objects, has been known for some time and is used preventively or when there is direct knowledge of a threat. Therefore, during attacks with guided missiles or with laser-guided munitions, warning sensors or reconnaissance radars are used that detect the attack as such and as a rule enable or initiate timely defensive measures. In practice, in the past initiation of a defensive measure has occurred purely as a precaution or only when the threat is reality, i.e. after the enemy has already fired shots.

Therefore fundamentally thorough intelligence efforts using optical systems and/or thermal imaging devices are undertaken to identify a threat in advance. In addition, self-protection is not initiated until a first shot has been fired. Intelligence means prior to an enemy firing shots include inter alia laser warning receivers that react to enemy laser rangefinders. It is disadvantageous that the time span between laser target tracking and firing of a shot in most cases is so short that any countermeasure comes too late. Moreover, the associated false alarm rate is so high that automatic or general initiation of self-protection measures in this regard is not recommended because the limited number of available countermeasures would be shot off too soon and at the same time the friendly position would be betrayed, even in a non-threat situation.

Known from DE 93 20 382 U1 is a self-protection system that has an additional device that, in addition to the required components, possesses an acoustic alarm, an aiming module for azimuth and elevation, a module for displaying the threat, and a visual alarm. In addition to various measures, threat data are automatically converted to firing parameters using this device, which is integrated into the available vehicle protection system. In addition, the operator is provided information both about the fact that there is a threat and also about the type of threat and the direction from which the threat emanates. In the evaluation, the operator is provided the results of the threat analysis and the firing parameters, such as type of munition, selection of launch tube, and orientation of launcher for launching.

DE 102 29 273 A1 also describes an object self-protection device. It has a target tracking radar device for tracking the approach of a missile that is to be defended against.

A device for protecting mobile objects, in particular armored vehicles, against projectiles can be taken from DE 197 47 515 C1. A plurality of sensors are distributed across the object for detecting the incoming projectile, so that a closed monitoring shield spans the object.

DE 102 30 939 A1 discloses a method and a device for protecting battlefield vehicles from threatened weapons. In this case as well, the self-protection suggested is traditionally preventive.

Therefore it is peculiar to the prior art that intelligence from surveillance represents a small chance with optimum counter-reaction. The use of laser or other warning devices does not provide an alarm until the enemy has begun shooting.

Thus the object of the invention is to provide a novel self-protection system that avoids the aforesaid disadvantages.

The object is attained using the features of patent claim 1. Advantageous embodiments are provided in the subordinate claims.

The invention proceeds from the basic idea of combining intelligence means for detecting enemy shooters and/or positions with pyrotechnic countermeasures. I.e., as soon as a shooter has been detected and before a shot has been fired from that location a countermeasure is already underway in order to harass the shooter. This countermeasure is initiated suddenly. Thus a protection system is created that can undertake a self-protection measure even prior to the shot being fired.

As is known, this countermeasure can be performed against a location-fixed launcher aimed in a threatening direction or against a launcher that can be aimed. A launcher that can be aimed is described for instance in DE 10 2005 020 177.6, which was not published in advance. A compartmented arrangement on the object is also possible.

Refer in particular to the entire specification in DE 102 30 939 A1 with regard to how the countermeasures work and are applied for a better understanding thereof.

Sensors are used for the warning or alarm system that have proved themselves in particular in detecting sharpshooters. Thus inter alia DE 44 39 850 C1 describes an apparatus for localizing artillery and rear cover positions that possess a sensor and acoustically triggered marking means.

However, laser warning systems, UV warning systems, flash-bang units, radar warning systems, etc., are also used.

The warning sensor system used is optimized for the provided applications so that a certain area around the object to be protected is scanned and monitored. The principle in a first and preferred embodiment is based on laser irradiation and monitoring of the reflection. Enemy optical systems can be detected in this manner.

These warning sensors can preferably be coupled to laser sensors, since normal optical systems and lasers are used for targeting.

Subsequently published DE 10 2005 006 726 A1 discloses for instance a method and an apparatus for detecting optical systems in a land area and can also be used as a sensor system for any threat. The apparatus has a movable mirror as well as a laser arrangement and a control device for determining the position of the shooter. Additional apparatus of this type are described in U.S. Pat. No. 6,057,915 A, WO 03/102626 A, and DE 44 12 044 A1, CCD cameras as well as 2D and 3D scanners representing an alternative.

When the warning sensors are actuated, an irritant munition is automatically launched, or is launched on command, in the direction of the potential threat, and it produces in particular an intense flash of light and heavy smoke or fog (concealment). The effect should occur spontaneously upon release directly from the vehicle or object. Preferably the self-protection launcher automatically pivots in the direction of the threat or the launcher aimed in the direction of the threat is controlled even before the final identification and decision to employ the countermeasure.

It is provided that an acoustic and/or optical alarm goes off.

The suggested solution has the advantage, inter alia, that by coupling intelligence about a gunner to an irritant, the enemy is disrupted while still targeting, which leads to a break in the battle or at least to a miss. While the gunner is re-aiming, a movable object can be moved beyond the threat, and a fixed object can be protected by fog or other concealment measures. At least, however, the shooter receives the information that he has been decamouflaged (e.g. by the transmission of an acoustic signal) and easily loses combat readiness.

For preventing high rates of false alarms, the warning sensor system can be combined with a visual intelligence system that can be aimed and that, given a threat from the warning sensor system, displays an enlargement of the detected area in a display for identification and provides the crew assistance in deciding on a countermeasure as such and also provides the type of countermeasure to be initiated. In one preferred variant a discrete optics system is integrated into each launcher that can be aimed.

A thermal imaging device can also be included instead of, or in addition to, the visual reconnaissance.

Automatic identification and reaction by the system without operator intervention is also provided. For this, automatic image evaluation is suggested that can be used to initiate the appropriate countermeasures automatically. The image evaluation can for instance compare with one another images that were recorded in sequence. Changes are registered, automatically evaluated, and the countermeasures are initiated using comparable scenarios (that can be stored in the system).

Thus for the first time it is possible to use pyrotechnic protective measures during direct combat in order to prevent, or at least impede, an enemy engagement (soft kill protection system). The apparatus is easily adaptable and thus can be useful and retrofitted, and not just on vehicles. It can also be employed on aircraft, seagoing vessels, buildings, etc. The present solution thus operates in the presence of a potential threat even prior to the actual, acute threat, i.e. after it has determined that there is a potential danger and with good foresight prior to a shot being fired, etc., in order not to initiate a countermeasure first in a reaction to the threat.

The invention shall be explained in greater detail using the following exemplary embodiment and the drawings.

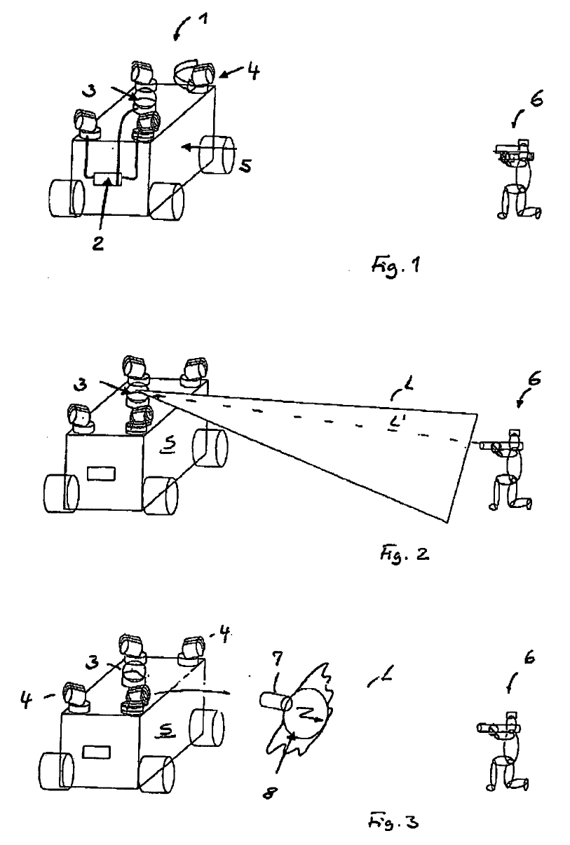

FIG. 1 depicts the principle for the structure of a self-protection system;

FIG. 2 depicts the manner in which the self-protection system works while monitoring the environment;

FIG. 3 depicts initiation of appropriate countermeasures.

FIG. 1 depicts the principle for the structure of a self-protection system 1 comprising at least one, as a rule, fire control computer 2, at least one sensor system or detection device 3 (warning sensor system), and one or a plurality of launching devices 4, preferably four to six thereof. In this exemplary embodiment the warning sensor system 3 is a so-called Sniper Location Detector, and the launching device 4 is a launch system that can preferably be aimed.

The launch systems 4 are electrically connected via control electronics (not shown in greater detail, for instance a fire control computer 2) and an operation and warning device (not shown in greater detail) that has at least one Sniper Location Detector 3. For panoramic vision, preferably four to six detectors 3 are used that are connected to one another on the object 5, for instance attached to a vehicle, to ensure this panoramic vision. The person or the like that represents the threat is labeled 6.

The suggested Sniper Location Detector(s) 3 suggested here preferably work on a laser irradiation L and the monitoring of the reflections L′ of these beams L (FIG. 2). The principle is known from the field of end-phase-guided munitions and is described in greater detail for instance in DE 196 04 745 C1.

After detecting a tank cover or rear cover position 6 (or other similar threat unit), the at least one launch system 4, which can be automatically coupled to the detector, is activated (FIG. 3).

Alternatively, manual initiation on an operating device that can be coupled to an acoustic and/or optical warning device is possible (not depicted in greater detail). The launch system 4 is equipped with a pyrotechnic munition 7, irritant bodies or munitions being primarily involved that produce an intense flash of light and/or smoke/fog 8 immediately upon being fired. For this, the irritant bodies also have a fog munition that envelops the object 5 or vehicle in a large amount of fog. In addition, using the ability of the at least one launch system 4 to be aimed or using the compartmented arrangement of rigid launching devices, it is also assured that a large area around the object 5 can be protected, since it is possible to shoot in the direction of the potential threat.

A laser warning receiver can be added to the warning sensor system 3. For better identification, the warning sensor system can be coupled to an optical system that can be aimed and that provides the operator an enlarged depiction of the detected threat. The protective system can have additional warning sensors such as missile warning systems, flash-bang units, or radars in order to be able to use the same system to defend against classic threats such as aircraft attacks, laser attacks, and other attacks.

1-19. (canceled)

20. A self-protection system for combat vehicles or other objects to be protected from a threat, comprising:
at least one launching device for initiating suitable countermeasures against the threat, the launching device being equipped with a pyrotechnic munition that primarily receives irritant bodies or munitions; and
a sensor system for detecting and localizing a tank cover and/or rear cover position as a potential threat, whereby a countermeasure is initiated immediately against the potential threat as soon as a tank cover and/or rear cover position is detected by said sensor system and before a shot has been fired from the potential threat.

21. The self-protection system in accordance with claim 20, wherein the countermeasure is an intense flash of light and/or smoke/fog.

22. The self-protection system in accordance with claim 20, wherein said sensor system is at least one Sniper Location Detector.

23. The self-protection system in accordance with claim 22, wherein said Sniper Location Detector works on a laser irradiation and monitoring of reflections of laser beams.

24. The self-protection system in accordance with claim 20, wherein said sensor system is a sensor and an acoustically triggered marking means and/or a laser warning system and/or a UV warning system and/or a radar warning system and/or a device that detects an optical system.

25. The self-protection system in accordance with claim 20, wherein said launching device is a launcher system.

26. The self-protection system in accordance with claim 20, wherein said launching device is compartmented.

27. The self-protection system in accordance with claims 20, wherein said launching device is aimable in a direction of the threat.

28. The self-protection system in accordance with claim 20, and further comprising control electronics that electrically connect said launching device to said sensor system.

29. The self-protection system in accordance claim 20, wherein the sensor system includes a plurality of sensors connected to one another on the object such that panoramic vision is ensured.

30. The self-protection system in accordance with claim 29, wherein the sensor system includes four to six sensors.

31. The self-protection system in accordance with claim 20, wherein the sensor system includes a laser warning receiver and/or a missile warning system.

32. The self-protection system in accordance with claim 20, wherein said system is operative to automatically shoot a protective measure in a direction of a threat upon detection of the threat.

33. The self-protection system in accordance with claim 20, wherein said launching device is semi-automatically aimable in a direction of the threat.

34. The self-protection system in accordance with claim 33, and further comprising a signal generator operative to generate an acoustic and/or optical warning signal when a threat has been detected, the protective countermeasure being initiated manually.

35. The self-protection system in accordance with claim 20, and further comprising an optical system that is pivotable, with a detection of a threat by said sensor system, in a direction of the threat and operative to provide an enlarged depiction of the threat in a display for identification.

36. The self-protection system in accordance with claim 35, wherein an image from the optical system is evaluated using an automatic image evaluation device and a protective countermeasure is automatically initiated when a threat is identified.

37. The self-protection system in accordance with claim 35, and further comprising a thermal imaging device that provides intelligence in addition to or instead of optical intelligence from the optical system.

38. The self-protection system in accordance claim 36, wherein, responsive to automatic identification of a threat by the automatic image evaluation device, changes are registered and automatically evaluated, and the countermeasures are initiated using comparable scenarios stored in the system.

39. The self-protection system in accordance with claim 38, wherein the image evaluation device is operative to perform the image evaluation by comparing images that were recorded in sequence.
